(19) United States
(12) Patent Application Publication
(10) Pub. No.: US 2026/0343123 A1
(43) Pub. Date: Oct. 29, 2026

(54) IMAGING DEVICE

(71) Applicant: SONY SEMICONDUCTOR SOLUTIONS CORPORATION, KANAGAWA (JP)

(72) Inventor: KO ISHIBASHI, KANAGAWA (JP)

(21) Appl. No.: 19/123,204

(22) PCT Filed: Sep. 21, 2023
(86) PCT No.: PCT/JP2023/034185

§ 371 Date: Apr. 22, 2025

(30) Foreign Application Priority Data
Oct. 31, 2022 (JP) 2022-174909

(51) Int. Cl. H04N 25/78; H04N 25/76; H04N 25/771; H04N 25/778

(52) U.S. Cl. CPC H04N 25/78; H04N 25/771; H04N 25/778; H04N 25/7795

(57) ABSTRACT

An imaging device according to an embodiment of the present disclosure includes: a sensor unit that generates image data of a reference image obtained by imaging an imaging target region with a resolution of a maximum angle of view and image data of a reduced image obtained by imaging the imaging target region with a resolution lower than the resolution of the reference image; and a logic unit that processes the image data. The sensor unit includes: a pixel array section including a plurality of pixels that each generates an analog pixel signal obtained by photoelectrically converting incident light from the imaging target region; a row selection section that selects a pixel that outputs the analog pixel signal from the pixel array section according to the resolution; and a signal processing section that generates image data by performing digital processing on the analog pixel signal of the pixel selected by the row selection section, indicates the resolution in the image data, and outputs the image data to the logic unit.

### TECHNICAL FIELD

The present disclosure relates to an imaging device.

### BACKGROUND ART

In recent years, in a web conference, a method of combining a preset image as a background image is used as means for protecting privacy of one's house or the like. However, in such image composition, when a person moves, a part of the house or the like is seen in some cases from a boundary between the background image and the person.

Therefore, there is known an image processing technique that detects a moving object region at the time of performing the image composition and does not perform the image composition only on the detected moving object region. Moreover, as a technique of improving detection accuracy of the moving object region, a technique of generating some reduced images with reduced resolution is known. According to this technique, a small mobile body can be detected by reducing a random noise (RN) error.

### CITATION LIST

Patent Document

Patent Document 1: Japanese Patent Application Laid-Open No. 2019-101977

### SUMMARY OF THE INVENTION

### Problems to be Solved by the Invention

In the technique described above, for example, the reduction processing for generating a reduced image is performed in a logic unit such as a digital signal processor (DSP). As the number of pieces of reduced images to be generated increases, a processing load on the logic unit increases.

Therefore, the present disclosure provides an imaging device that can reduce a processing load of a reduced image in a logic unit.

### Solutions to Problems

An imaging device according to an embodiment of the present disclosure includes: a sensor unit that generates image data of a reference image obtained by imaging an imaging target region with a resolution of a maximum angle of view and image data of a reduced image obtained by imaging the imaging target region with a resolution lower than the resolution of the reference image; and a logic unit that processes the image data. The sensor unit includes: a pixel array section including a plurality of pixels that each generates an analog pixel signal obtained by photoelectrically converting incident light from the imaging target region; a row selection section that selects a pixel that outputs the analog pixel signal from the pixel array section according to the resolution; and a signal processing section that generates the image data by performing digital processing on the analog pixel signal of the pixel selected by the row selection section, indicates the resolution in the image data, and outputs the image data to the logic unit.

Each of the plurality of pixels may include:
a photoelectric conversion circuit having a light receiving element that photoelectrically converts the incident light;
a first source follower circuit including a first amplification transistor that amplifies an output signal of the photoelectric conversion circuit;
a signal holding circuit that holds an output signal of the first source follower circuit; and
a second source follower circuit including a second amplification transistor that amplifies a signal read from the signal holding circuit, and a selection transistor that selects, on the basis of control of the row selection section, whether or not to transmit a signal amplified by the second amplification transistor to the signal processing section as the analog pixel signal.

The number of selection transistors in the plurality of pixels in an on state may decrease as the resolution decreases.

The plurality of pixels may be aligned in a matrix in the pixel array section, and
the selection transistors each being provided in each of pixels belonging to the same pixel column in the plurality of pixels may be commonly connected to one signal line.

The sensor unit may further include a switch element that switches whether or not to connect the signal lines to each other on the basis of control of the row selection section.

The switch element may switch whether or not to connect signal lines to each other, the signal lines being connected to a pixel column having the same combination of received colors of the pixels.

The switch element may switch whether or not to connect signal lines to each other, the signal lines being disposed at every other position in a row direction.

The row selection section may turn on the switch element simultaneously with the selection transistor.

The switch element may include an N-channel metal-oxide-semiconductor (MOS) transistor.

The signal holding circuit may include:
a first capacitive element that holds a first signal obtained by resetting the photoelectric conversion circuit;
a first sample transistor that sets, on the basis of control of the row selection section, timing of holding the first signal in the first capacitive element;
a second capacitive element that holds a second signal generated by performing photoelectric conversion by the photoelectric conversion circuit; and
a second sample transistor that sets, on the basis of control of the row selection section, timing of holding the second signal in the second capacitive element.

The resolution may be indicated in a header or a footer of the image data.

The signal processing section may include:
an analog-to-digital (AD) converter that converts the analog pixel signal into a digital pixel signal; and
a processing circuit that generates the image data on the basis of the digital pixel signal, indicates the resolution in the image data, and outputs the image data to the logic unit.

The sensor unit may generate image data of two reference images having different imaging timings from each other and image data of a plurality of reduced images having different resolutions from each other, and
the logic unit may include:
a moving object region detection section that detects a moving object region in the reference image on the basis of the plurality of reduced images; and
an image composition section that combines the two reference images on the basis of a detection result of the moving object region detection section.

### BRIEF DESCRIPTION OF DRAWINGS

FIG. 1 is a block diagram illustrating a configuration of an imaging device according to a first embodiment.

FIG. 2 is a diagram illustrating a configuration of a sensor unit according to the first embodiment.

FIG. 3 is a diagram illustrating a circuit configuration of a pixel and a signal processing section according to the first embodiment.

FIG. 4 is a block diagram illustrating a schematic configuration of a logic unit.

FIG. 5 is a diagram illustrating an example of a two-layer structure of the sensor unit.

FIG. 6 is a diagram illustrating an example of a three-layer structure of the sensor unit.

FIG. 7 is a flowchart illustrating an operation procedure of the imaging device according to the first embodiment.

FIG. 8 is a timing chart for explaining imaging processing in the sensor unit according to the first embodiment.

FIG. 9 is a schematic diagram illustrating an example of a structure of image data of the sensor unit.

FIG. 10 is a diagram showing a circuit configuration of a pixel in an imaging device according to a comparative example.

FIG. 11 is a block diagram illustrating a configuration of a sensor unit 20 of an imaging device 2 according to a second embodiment.

FIG. 12 is a block diagram illustrating an example of a schematic configuration of a vehicle control system.

FIG. 13 is an explanatory diagram illustrating an example of installation positions of an outside-vehicle information detecting section and an imaging section.

### MODE FOR CARRYING OUT THE INVENTION

### First Embodiment

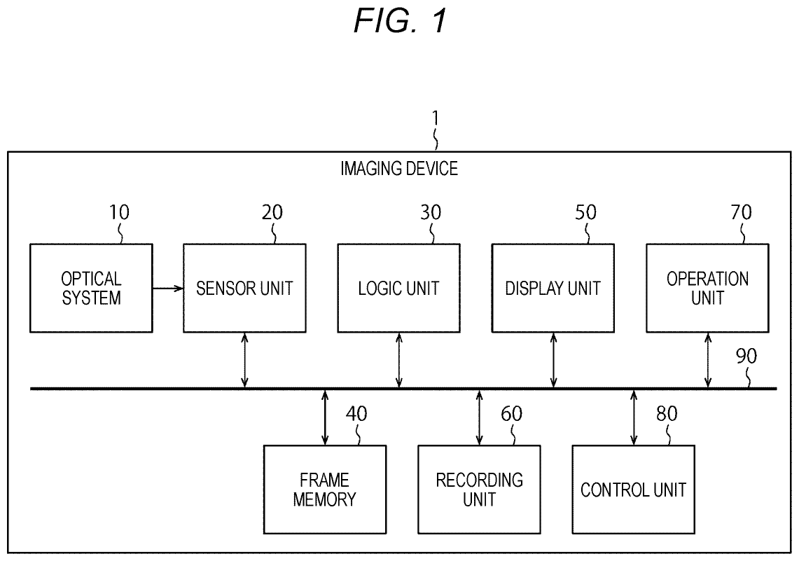

FIG. 1 is a block diagram illustrating a configuration example of an imaging device according to a first embodiment. As illustrated in FIG. 1, an imaging device 1 includes an optical system 10, a sensor unit 20, a logic unit 30, a frame memory 40, a display unit 50, a recording unit 60, an operation unit 70, and a control unit 80. The sensor unit 20, the logic unit 30, the frame memory 40, the display unit 50, the recording unit 60, the operation unit 70, and the control unit 80 are mutually connected via a bus line 90. The imaging device 1 can be applied to, for example, a web camera used in a web conference, a monitoring camera installed in a monitoring place, an in-vehicle camera, and the like.

The optical system 10 includes a lens group and the like that captures incident light (image light) from an imaging target region and forms an image on an imaging surface of the sensor unit 20. The sensor unit 20 generates image data obtained by converting the light quantity of incident light formed as an image on the imaging surface by the optical system 10 into an electrical signal in units of pixels. The logic unit 30 includes, for example, a digital signal processing (DSP) circuit, and performs predetermined image processing on the image data generated by the sensor unit 20.

The frame memory 40 is appropriately used for storing data in the process of signal processing of the sensor unit 20 and image processing of the logic unit 30.. The display unit 50 includes a panel-type display device such as a liquid crystal display device and an organic electro luminescence (EL) display device, and displays a captured image of the imaging device 1.

The recording unit 60 includes a recording medium such as a portable semiconductor memory, an optical disk, or a hard disk drive (HDD), and records a captured image of the imaging device 1.

The operation unit 70 issues operation commands for various functions of the sensor unit 20 by an operation performed by a user. The control unit 80 controls operations of the sensor unit 20, the logic unit 30, the frame memory 40, the display unit 50, the recording unit 60, and the operation unit 70.

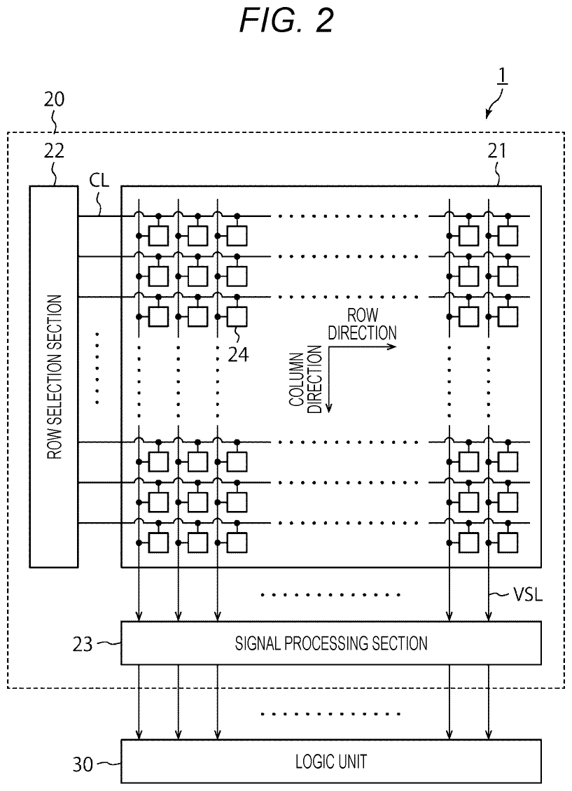

FIG. 2 is a block diagram illustrating a configuration of the sensor unit 20 according to the first embodiment. The sensor unit 20 according to the present embodiment includes a pixel array section 21, a row selection section 22, and a signal processing section 23.

In the pixel array section 21, a plurality of pixels 24 is two-dimensionally arranged in a matrix in a row direction and a column direction. Here, the row direction is the alignment direction in which the pixels 24 are arranged in the horizontal direction, and the column direction is orthogonal to the row direction and is the alignment direction in which the pixels 24 are arranged in the vertical direction. The pixel 24 performs photoelectric conversion on incident light to generate and accumulate charges corresponding to an amount of received light.

In the pixel array section 21, pixel control lines CL are wired along the row direction for every pixel row. Furthermore, signal lines VSL are wired in the column direction for every pixel column. The pixel control line CL transmits a drive signal for driving at the time of reading an analog pixel signal from the pixel 24. One end of the pixel control line CL is connected to a corresponding output end of each row of the row selection section 22.

The row selection section 22 includes a shift register, an address decoder, and the like, and controls scanning for the pixel row and addressing of the pixel row at the time of selecting each pixel 24 of the pixel array section 21. Although illustration of a specific configuration of the row selection section 22 is omitted, the configuration generally includes two scanning systems, which are a read scanning system and a sweep scanning system.

The read scanning system selectively scans the pixels 24 in the pixel array section 21 sequentially row by row to read a pixel signal from each pixel 24. The pixel signal read from the pixel 24 is an analog signal. The sweep scanning system performs sweep scanning on a read row subjected to read scanning by the read scanning system earlier than the read scanning by an amount of time corresponding to a shutter speed.

By the sweep scanning being performed by the sweep scanning system, unnecessary charges are swept out from photoelectric conversion elements of the pixels 24 in the read row, and thus, the photoelectric conversion elements are reset. Then, by sweeping out (resetting) the unnecessary charges by the sweeping scanning system, a so-called electronic shutter operation is performed. Herein, the electronic shutter operation means operation to discharge the charges of the photoelectric conversion element and newly start exposing (start accumulating charges).

The signal processing section 23 performs signal processing such as analog to digital (AD) conversion processing of converting an analog pixel signal generated in the pixel array section 21 into a digital pixel signal and correlated double sampling (CDS) processing of removing fixed pattern noise unique to the pixel 24.

Note that, in FIG. 2, the signal processing section 23 is disposed on one side (lower side in FIG. 1) in the column direction of the pixel array section 21, but another signal processing section 23 may be disposed on the other side (upper side in FIG. 1) in the column direction. In this t case, the another signal processing section 23 also processes the analog pixel signal output from the pixel array section 21. Furthermore, another logic unit 30 connected to the another signal processing section 23 is also disposed. The another logic unit 30 performs predetermined image processing on the output signal of the another signal processing section 23.

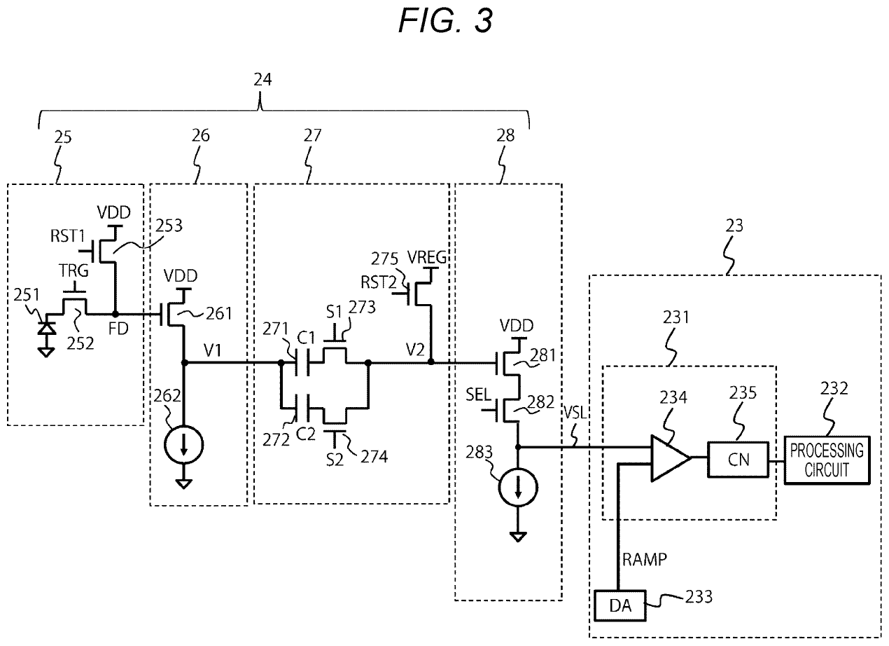

FIG. 3 is a diagram illustrating a circuit configuration of the pixel 24 and the signal processing section 23 according to the first embodiment.

First, the circuit configuration of the pixel 24 will be described. The pixel 24 includes a photoelectric conversion circuit 25, a first source follower circuit 26, a signal holding circuit 27, and a second source follower circuit 28. Hereinafter, each of the circuits will be described.

The photoelectric conversion circuit 25 includes a light receiving element 251, a transfer transistor 252, and a first reset transistor 253. A photodiode such as an avalanche photodiode can be applied to the light receiving element 251. The light receiving element 251 receives the incident light and accumulates photocharges according to the amount of received light. An anode of the light receiving element 251 is connected to a low potential side power supply (for example, ground) . A cathode of the light receiving element 251 is connected to the first source follower circuit 26 via the transfer transistor 252.

The transfer transistor 252 includes, for example, an N-channel MOS transistor. A transfer signal TRG is input to the gate of the transfer transistor 252 from the row selection section 22 through the pixel control line CL. When the transfer transistor 252 becomes the on state in accordance with the level of the transfer signal TRG, the photocharges accumulated in the light receiving element 251 is transferred to a floating diffusion (floating diffusion region/impurity diffusion region) FD. The floating diffusion FD is an electrical connection region between the transfer transistor 252 and the first source follower circuit 26, and functions as a charge-voltage conversion unit that converts the photocharges photoelectrically converted by the light receiving element 251 into a voltage signal.

The first reset transistor 253 is connected between a positive power supply for supplying a power supply voltage VDD and the floating diffusion FD. The first reset transistor 253 includes, for example, an N-channel MOS transistor, and the gate thereof receives a first reset signal RST1 from the row selection section 22 through the pixel control line CL. When the first reset transistor 253 becomes the on state on the basis of the first reset signal RST1 of high level, the charges of the floating diffusion FD are discharged to the positive power supply described above. With this arrangement, the floating diffusion FD is reset.

The first source follower circuit 26 is a circuit for amplifying the voltage signal held in the floating diffusion FD, and includes a first amplification transistor 261 and a first current source 262.

The first amplification transistor 261 is an element for amplifying the output signal of the photoelectric conversion circuit 25, and includes, for example, an N-channel MOS transistor. The gate of the first amplification transistor 261 is connected to the floating diffusion FD. Furthermore, the drain of the first amplification transistor 261 is connected to the positive power supply for supplying the power supply voltage VDD. Moreover, the source of the first amplification transistor 261 is connected to the first current source 262. The first amplification transistor 261 amplifies and outputs the voltage signal read from the floating diffusion FD.

The first current source 262 is connected in series to the first amplification transistor 261, and supplies a constant current to the first amplification transistor 261 on the basis of the control of the row selection section 22.

In the first source follower circuit 26, a reset signal (first signal) and a data signal (second signal) are sequentially output from the first amplification transistor 261. This reset signal corresponds to a so-called P-phase signal, and indicates a voltage level of the time when the first reset transistor 253 becomes the on state and the photoelectric conversion circuit 25 is in a reset state. On the other hand, the data signal corresponds to a so-called D-phase signal, and indicates a voltage level based on the amount of charge accumulated in the floating diffusion FD by photoelectric conversion of the light receiving element 251.

The signal holding circuit 27 is a circuit for holding the voltage of the reset signal and the voltage of the data signal, and includes a first capacitive element 271, a second capacitive element 272, a first sample transistor 273, a second sample transistor 274, and a second reset transistor 275.

The first capacitive element 271 is an element for holding the voltage of the reset signal. The second capacitive element 272 is an element for holding the voltage of the data signal. One end of each of the first capacitive element 271 and the second capacitive element is connected to an input node V1. The other end of the first capacitive element 271 is connected to the first sample transistor 273, and the other end of the second capacitive element 272 is connected to the second sample transistor 274. Note that a capacitance value C1 of the first capacitive element 271 and a capacitance value C2 of the second capacitive element 272 only need to be values that enable the voltages of the reset signal and the data signal to be held respectively, and may be the same value or different values from each other.

The first sample transistor 273 is an element for setting a timing of holding the reset signal in the first capacitive element 271, and is constituted of, for example, an N-channel MOS transistor. A first sample-and-hold signal S1 is input to the gate of the first sample transistor 273 from the row selection section 22 through the pixel control line CL. Furthermore, the drain of the first sample transistor 273 is connected to the other end of the first capacitive element 271, and the source thereof is connected to the second reset transistor 275 and the second source follower circuit 206. When the first sample transistor 273 becomes the on state on the basis of the first sample-and-hold signal S1 of high level, the reset signal is held in the first capacitive element 271.

The second sample transistor 274 is an element for setting a timing of holding the data signal in the second capacitive element 272, and is constituted of, for example, an N-channel MOS transistor. A second sample-and-hold signal S2 is input to the gate of the second sample transistor 274 from the row selection section 22 through the pixel control line CL. Furthermore, the drain of the second sample transistor 274 is connected to the other end of the second capacitive element 272, and the source thereof is connected to the second reset transistor 275 and the second source follower circuit 206. When the second sample transistor 274 becomes the on state on the basis of the second sample-and-hold signal S2 of high level, the data signal is held in the second capacitive element 272.

The second reset transistor 275 is an element for resetting the potential of an output node V2 of the signal holding circuit 27, and includes, for example, an N-channel MOS transistor. A second reset signal RST2 is input to the gate of the second reset transistor 275 from the row selection section 22 through the pixel control line CL. Furthermore, the drain of the second reset transistor 275 is connected to a regulator that outputs a constant voltage VREG. The constant voltage VREG is set to a potential lower than the power supply voltage VDD. Moreover, the source of the second reset transistor 275 is connected to the source of each of the first sample transistor 273 and the second sample transistor 274. When the second reset transistor 275 becomes the on state on the basis of the second reset signal RST2 of high level, the potential of the output node V2 is reset to the constant voltage VREG.

The second source follower circuit 28 is a circuit for selectively reading and amplifying the reset signal or the data signal from the signal holding circuit 27, and includes a second amplification transistor 281, a selection transistor 282, and a second current source 283. Note that, in the present embodiment, the second source follower circuit 28 is provided for every pixel 24, but may be shared by the plurality of pixels 24 commonly connected to the signal line VSL.

The second amplification transistor 281 is an element for amplifying the reset signal and the data signal read from the signal holding circuit 27, and includes, for example, an N-channel MOS transistor. The gate of the second amplification transistor 281 is connected to the output node V2 of the signal holding circuit 27. Furthermore, the drain of the second amplification transistor 281 is connected to the positive power supply for supplying the power supply voltage VDD. Moreover, the source of the second amplification transistor 281 is connected to the selection transistor 282.

The selection transistor 282 is an element for selecting whether or not to transmit the reset signal or the data signal amplified by the second amplification transistor 281 to an AD converter 231, and includes, for example, an N-channel MOS transistor. A selection signal SEL is input to the gate of the selection transistor 282 from the row selection section 22 through the pixel control line CL. Furthermore, the drain of the selection transistor 282 is connected to the source of the second amplification transistor 281, and the source thereof is connected to the second current source 283 and the signal line VSL. When the selection transistor 282 becomes the on state on the basis of the selection signal SEL of high level, an output signal of the second amplification transistor 281, that is, an analog pixel signal is transmitted to the AD converter 231 through the signal line VSL. The selection transistors 282 each provided in each of the pixels 24 belonging to the same pixel column are commonly connected to one signal line VSL.

The second current source 283 is connected in series to the selection transistor 282. The second current source 283 supplies a constant current to the second amplification transistor 281 and the selection transistor 282 on the basis of the control of the row selection section 22.

Next, a configuration of the signal processing section 23 will be described. The signal processing section 23 includes an AD converter 231, a processing circuit 232, and a signal generation circuit 233.

The signal processing section 23 is provided with a plurality of the AD converters 231 correspondingly to the pixel columns of the pixel array section 21 (for example, for every pixel column,). The plurality of AD converters 231 function as column-parallel analog to digital converters that convert an analog pixel signal output through each of the signal lines VSL into a digital pixel signal.

Each AD converter 231 includes a comparator 234 and a counter 235 (CN). The comparator 234 compares the pixel signal generated by the pixel 24 with a ramp signal RAMP of a triangular wave. When the voltage of the pixel signal matches, in other words, crosses the voltage of the ramp signal RAMP, the output signal level of the comparator 234 is inverted. The counter 235 measures the number of inverted times of the output signal level of the comparator 234 within a unit time (frame time).

The processing circuit 232 performs signal processing such as the CDS processing on the digital pixel signal digitally converted by each of the AD converters 231 to create image data. The created image data is stored in the frame memory 40. Note that the processing circuit 232 may perform not only the CDS processing but also, for example, signal processing such as correction of a vertical line defect and a point defect, signal clamping, and parallel-serial conversion.

The signal generation circuit 233 (DA) generates and outputs the ramp signal RAMP to the comparator 234. The signal generation circuit 233 includes, for example, a current integration type digital to analog converter (DAC) or the like provided for every pixel column. The ramp signal RAMP is generated by using this digital to analog converter.

In the sensor unit 20 configured as described above, the row selection section 22 can reduce the resolution of the image by adjusting the number of pieces of the selection transistors 282 to be turned on. For example, in a case where a ¼ image having a resolution of ¼ with respect to a 1/1 image having the maximum angle of view is captured, the number of pieces of the selection transistors 282 to be turned on is ¼ of the 1/1 image. Furthermore, in a case where a 1/16 image having a resolution of 1/16 with respect to a 1/1 image or a 1/64 image having a resolution of 1/64 with respect to a 1/1 image is captured, the number of pieces of the selection transistors 282 to be turned on is 1/16 or 1/64 of the 1/1 image.

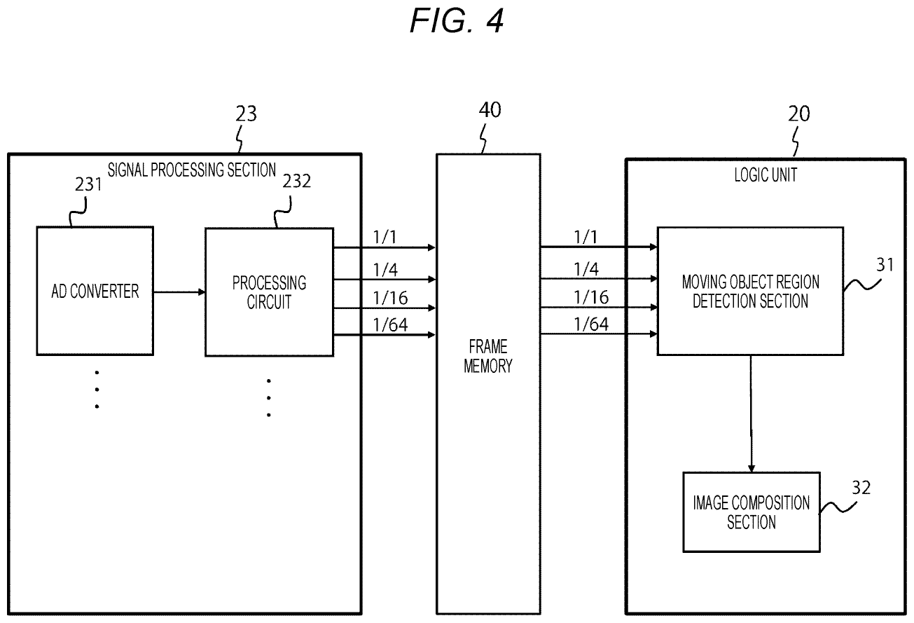

FIG. 4 is a block diagram illustrating a schematic configuration of the logic unit 30. The logic unit 30 illustrated in FIG. 4 includes a moving object region detection section 31 and an image composition section 32. The moving object region detection section 31 reads a plurality of reduced images whose resolution is reduced by the sensor unit 20 from the frame memory 40, and detects a moving object region in the captured image of the sensor unit 20. The image composition section 32 combines a first reference image captured by the sensor unit 20 and a second reference image having the same imaging range as the first reference image and captured by the sensor unit 20 at a later timing than the first reference image by using the detection result of the moving object region detection section 31.

Note that the configuration of the logic unit 30 is not limited to the configuration illustrated in FIG. 4. The logic unit 30 may include an image processing circuit that performs general camera image processing, for example, white balance processing, demosaic processing, gamma correction processing, and the like.

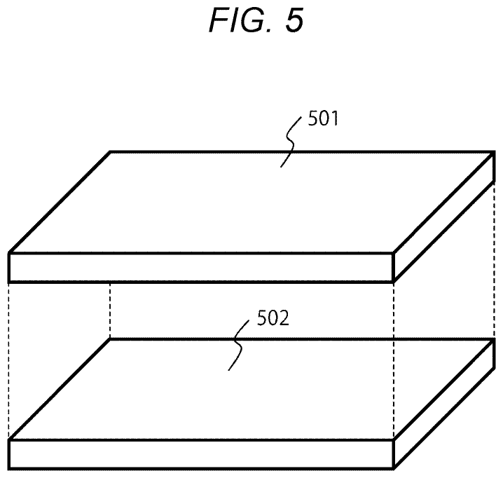

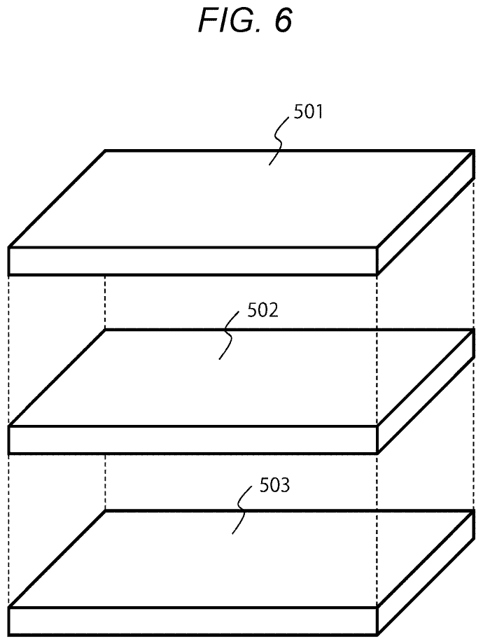

Here, a laminate structure of the sensor unit 20 will be described with reference to FIGS. 5 and 6.

FIG. 5 is a diagram illustrating an example of a two-layer structure of the sensor unit 20. In FIG. 5, in FIG. 5, a second substrate 502 is laminated on the lower side of a first substrate 501, and these two substrates are bonded to each other. The first substrate 501 and the second substrate are semiconductor substrates such as silicon substrates.

In the two-layer structure illustrated in FIG. 5, for example, the photoelectric conversion circuit 25 of the pixel 24 and the first amplification transistor 261 of the first source follower circuit 26 are disposed on the first substrate 501. In this case, the first current source 262 of the first source follower circuit 26, the signal holding circuit 27, and the second source follower circuit 28 are disposed on the second substrate 502. Furthermore, the signal processing section 23 is also disposed on the second substrate 502.

FIG. 6 is a diagram illustrating an example of a three-layer structure of the pixel 24. In FIG. 6, the pixels 24 are dispersedly disposed on the first substrate 501, the second substrate 502, and a third substrate 503. The third semiconductor substrate 3 is a semiconductor substrate such as a silicon substrate, which is the same as the first substrate 501 and the second substrate. In FIG. 6, the third substrate 503 is laminated on the lowermost layer, and these three substrates are bonded to each other.

In the three-layer structure illustrated in FIG. 6, for example, the light receiving element 251 and the transfer transistor 252 of the photoelectric conversion circuit 25 are disposed on the first substrate 501. The first reset transistor 253 of the photoelectric conversion circuit 25 and the first source follower circuit 26 are disposed on the second substrate 502. The signal holding circuit 27 and the second source follower circuit 28 are disposed on the third substrate 503. Furthermore, the signal processing section 23 is also disposed on the third substrate 503.

Note that the laminated structure of the pixel 24 is not limited to the two-layer structure illustrated in FIG. 5 or the three-layer structure illustrated in FIG. 6. For example, the first capacitive element 271 and the second capacitive element 272 may be realized by using the first substrate 501 and the second substrate 502. In this case, a pair of conductors facing each other is disposed on each of the first substrate 501 and the second substrate 502. The capacitance value of each of the first capacitive element 271 and the second capacitive element 272 can be set by adjusting the distance between the pair of conductors.

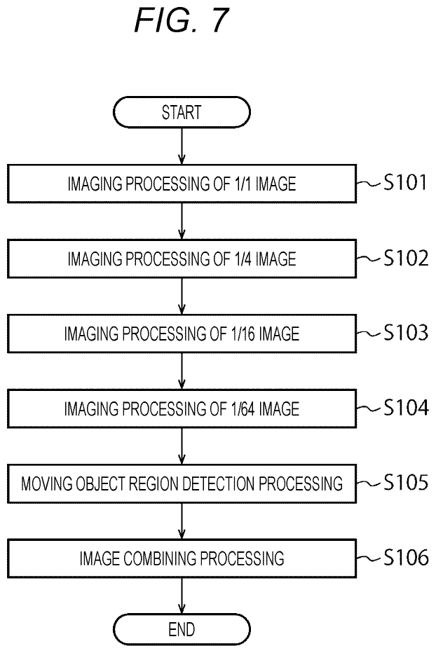

Hereinafter, the operation of the imaging device 1 according to the first embodiment is described with reference to FIG. 7. FIG. 7 is a flowchart illustrating an operation procedure of the imaging device 1 according to the first embodiment.

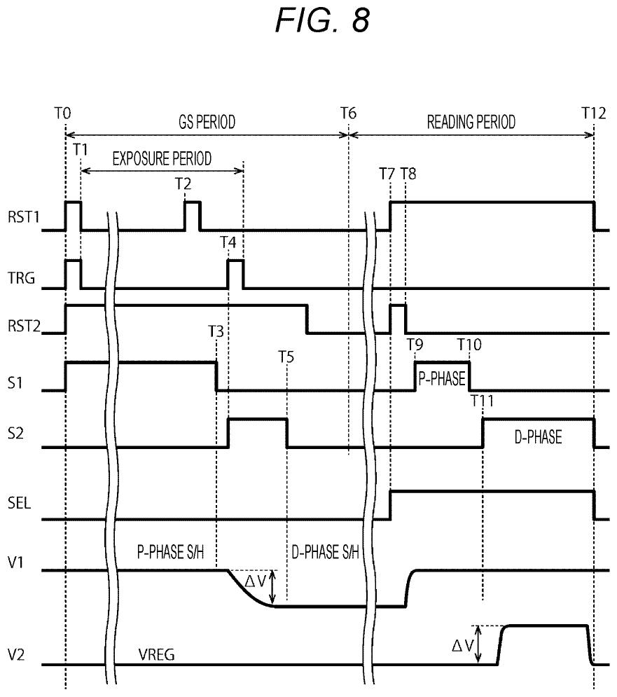

In the flowchart illustrated in FIG. 7, the sensor unit 20 captures a 1/1 image (step S101). Here, the operation in step S101 will be described in detail with reference to FIG. 8.

FIG. 8 is a timing chart for explaining the imaging processing in the sensor unit 20 according to the first embodiment. FIG. 8 illustrates waveforms of the first reset signal RST1, the transfer signal TRG, the second reset signal RST2, the first sample-and-hold signal S1, the second sample-and-hold signal S2, the selection signal SEL, the input node V1, and the output node V2.

First, in a period from timing T0 to timing T1, the row selection section 22 supplies the first reset signal RST1 of high level and the transfer signal TRG to the plurality of pixels 24 arranged in a matrix in the pixel array section 21. With this arrangement, in each pixel 24, the first reset transistor 253 is turned on on the basis of the first reset signal RST1, and the transfer transistor 252 is turned on on the basis of the transfer signal TRG. With this arrangement, each pixel 24 is reset, and a global switching period (hereinafter, referred to as a GS period) in which exposure is performed in the same period in each pixel row is started.

At timing T0, the row selection section 22 also supplies the second reset signal RST2 of high level to each of the pixels 24. With this arrangement, in each pixel 24, because the second reset transistor 275 is turned on, the voltages of the first capacitive element 271 and the second capacitive element 272 are reset to the constant voltage VREG. Furthermore, at timing T0, the first sample transistor 273 is in an on state on the basis of the first sample-and-hold signal S1 of high level, while the second sample transistor 274 is in an off state on the basis of the second sample-and-hold signal S2 of low level.

At timing T2 during the GS period, the first reset transistor 253 is turned on again on the basis of the first reset signal RST1 of high level. At this time, because the transfer signal TRG is at the low level, the transfer transistor 252 is in an off state. Subsequently, at timing T3 of when the first sample-and-hold signal S1 changes from the high level to the low level, the voltage value of the reset signal is sampled and held in the first capacitive element 271 (P-phase S/H).

Subsequently, at timing T4 at which the transfer transistor 252 is turned on again on the basis of the transfer signal TRG of high level, the second sample-and-hold signal S2 changes from the low level to the high level. With this arrangement, the second sample transistor 274 is switched from the off state to the on state. At this time, the first sample transistor 273 is in an off state on the basis of the first sample-and-hold signal S1 of low level.

Subsequently, at timing T5 of when the second sample-and-hold signal S2 changes from the high level to the low level, the voltage value of the data signal corresponding to the amount of charge that has been photoelectrically converted by the light receiving element 251 is sampled and held in the second capacitive element 272 (D-phase S/H). The voltage level of the data signal is lower by AV than the voltage level of the reset signal.

At timing T6 of when the GS period ends, because the second sample-and-hold signal S2 is at the low level, the second sample transistor 274 becomes the off state similarly to the first sample transistor 273.

Subsequently, at timing T7, a reading period of reading each of the voltage values of the reset signal and the data signal held in the signal holding circuit 27 is started. In the reading period, the row selection section 22 inputs the selection signal SEL of high level to the gate of the selection transistor 282 of the pixel 24 determined in advance according to the resolution of the 1/1 image. Therefore, the reading period is a period in which the reset signal and the data signal held in the signal holding circuit 27 can be transmitted to the AD converter 231.

Subsequently, in a period from timing T7 to timing T8, because the second reset signal RST2 of high level is input to the gate of the second reset transistor 275, the second reset transistor 275 becomes the on state, and the potential of the output node V2 is reset to the constant voltage VREG.

Subsequently, in a P-phase period from timing T9 to timing T10, the first sample-and-hold signal S1 is at the high level. With this arrangement, because the first sample transistor 273 becomes the on state, the reset signal is read to the second source follower circuit 28. This reset signal is amplified by the second amplification transistor 281. The amplified reset signal is transmitted from the selection transistor 282 to the AD converter 231 through the signal line VSL. In the P-phase period, when the voltage of the reset signal matches the voltage of the ramp signal RAMP input from the signal generation circuit 233 to the input terminal of the AD converter 231, the output signal of the AD converter 231 is inverted from the high level to the low level. Subsequently, the counter 235 measures the number of inverted times of the output signal of the AD converter 231.

Subsequently, in a D-phase period from timing T11 to timing T12, the first sample-and-hold signal S1 becomes the low level, while the second sample-and-hold signal S2 becomes the high level. With this arrangement, because the second sample transistor 274 becomes the on state, the data signal is amplified by the second amplification transistor 281. The amplified data signal is transmitted from the selection transistor 282 to the AD converter 231 through the signal line VSL. Also in the D-phase period, when the voltage of the data signal matches the voltage of the ramp signal RAMP, the output signal of the AD converter 231 changes from the high level to the low level. Subsequently, the counter 235 measures the number of inverted times of the output signal of the AD converter 231.

Subsequently, as the CDS processing, the processing circuit 232 calculates a difference between the measurement value of the counter 235 corresponding to the data signal and the measurement value of the counter 235 corresponding to the reset signal. This difference value is stored in the frame memory 40 as the pixel value of the first reference image having the maximum resolution ( 1/1). Thereafter, when the sensor unit 20 performs the imaging processing again on the basis of the timing chart illustrated in FIG. 8, the pixel value of the second reference image having the maximum resolution ( 1/1) is stored in the frame memory 40. The second reference image is an image captured after the first reference image. With this arrangement, the operation of step S101 ends.

Next, referring back to FIG. 7, the sensor unit 20 captures a ¼ image (step S102). This ¼ image includes a ¼ first reference image obtained by reducing the resolution of the 1/1 first reference image captured in step S101 to ¼, and a ¼ second reference image obtained by reducing the resolution of the 1/1 second reference image captured in step S101 to ¼. In step S102, similarly to step S101, the sensor unit 20 captures the ¼ first reference image and the ¼ second reference image according to the flowchart illustrated in FIG. 8.

However, in step S102, in the reading period, the row selection section 22 inputs the selection signal SEL of high level to the gate of the selection transistor 282 of the pixel 24 determined in advance such that the resolution becomes ¼. Because the resolution of the ¼ image is smaller than the resolution of the 1/1 image, the number of pieces of the selection transistors 282 whose gates receive the selection signal SEL of high level, that is, the number of selection transistors 282 to be turned on, is reduced. For example, in the ¼ image, the number of pieces of the selection transistors 282 to be turned on is set to ¼ of the 1/1 image.

Furthermore, in step S102, the processing circuit 232 calculates the pixel value of the ¼ first reference image and the pixel value of the ¼ second reference image in the similar manner as in step S101. The calculated pixel value is stored in the frame memory 40. With this arrangement, the operation of step S102 ends.

Next, the sensor unit 20 captures a 1/16 image (step S103). This 1/16 image includes a 1/16 first reference image obtained by reducing the resolution of the 1/1 first reference image captured in step S101 to 1/16, and a 1/16 second reference image obtained by reducing the resolution of the 1/1 second reference image captured in step S101 to 1/16. In step S103, similarly to step S101, the sensor unit 20 captures the 1/16 first reference image and the 1/16 second reference image according to the flowchart illustrated in FIG. 8.

However, in step S103, in the reading period, the row selection section 22 inputs the selection signal SEL of high level to the gate of the selection transistor 282 of the pixel 24 determined in advance such that the resolution becomes 1/16. Because the resolution of the 1/16 image is smaller than the resolution of the 1/1 image, the number of pieces of the selection transistors 282 whose gates receive the selection signal SEL of high level, that is, the number of selection transistors 282 to be turned on, is reduced. For example, in the 1/16 image, the number of pieces of the selection transistors 282 to be turned on is set to 1/16 of the 1/1 image.

Furthermore, in step S103, the processing circuit 232 calculates the pixel value of the 1/16 first reference image and the pixel value of the 1/16 second reference image in the similar manner as in step S101. The calculated pixel value is stored in the frame memory 40. With this arrangement, the operation of step S103 ends.

Next, the sensor unit 20 captures a 1/64 image (step S104). This 1/64 image includes a 1/16 first reference image obtained by reducing the resolution of the 1/1 first reference image captured in step S101 to 1/64, and a 1/64 second reference image obtained by reducing the resolution of the 1/1 second reference image captured in step S101 to 1/64. In step S104, similarly to step S101, the sensor unit 20 captures the 1/64 first reference image and the 1/64 second reference image according to the flowchart illustrated in FIG. 8.

However, in step S104, in the reading period, the row selection section 22 inputs the selection signal SEL of high level to the gate of the selection transistor 282 of the pixel 24 determined in advance such that the resolution becomes 1/64. Because the resolution of the 1/64 image is smaller than the resolution of the 1/1 image, the number of pieces of the selection transistors 282 whose gates receive the selection signal SEL of high level, that is, the number of selection transistors 282 to be turned on, is reduced. For example, in the 1/64 image, the number of pieces of the selection transistors 282 to be turned on is set to 1/64 of the 1/1 image.

Furthermore, in step S104, the processing circuit 232 calculates the pixel value of the 1/64 first reference image and the pixel value of the 1/64 second reference image in the similar manner as in step S101. The calculated pixel value is stored in the frame memory 40. With this arrangement, the operation of step S104 ends.

Note that, in the present embodiment, the number of times of the image reduction processing is set to three times, for ¼, 1/16, and 1/64, but for example, the resolution may be twice, for ¼ and 1/16. Furthermore, the image reduction ratios of the image are set to ¼, 1/16, and 1/64, but are not limited to these values.

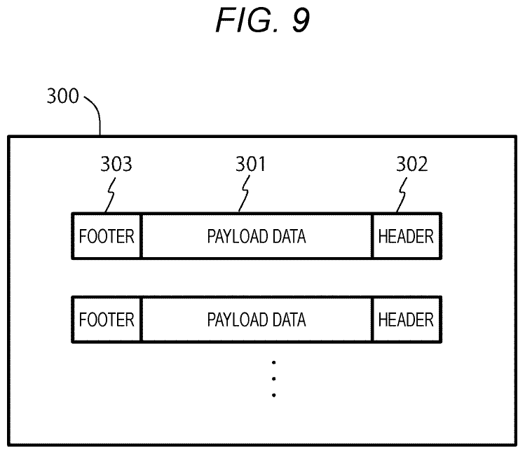

FIG. 9 is a schematic diagram illustrating an example of a structure of the image data of the sensor unit 20. Image data 300 illustrated in FIG. 9 is transmitted to the frame memory 40 by the processing circuit 232 in a packet method, and includes payload data 301, a header 302, and a footer 303.

In the payload data 301, a pixel value of the pixels 24 belonging to the same pixel column (signal line VSL) in the pixel array section 21 is indicated. This pixel value corresponds to a counter value of the counter 235. Because the pixel array section 21 includes the plurality of pixel columns (signal lines VSL) as illustrated in FIG. 1, the image data 300 of the first reference image and the second reference image includes pieces of the payload data 301, the headers 302, and the footers 303 of the number of pieces of pixel columns.

In the header 302, data indicating the number, resolution, and the like of the belonging pixel column is embedded. For example, in a case where the sensor unit 20 outputs ¼ image data, the header 302 indicates that the resolution is ¼. With this arrangement, the logic unit 30 can identify the resolution at the time of processing the image data 300. Note that all or part of the data embedded in the header 302 may be embedded in the footer 303.

When the reduction processing in steps S102 to S104 ends, the process returns to FIG. 7, and the moving object region detection section 31 of the logic unit 30 detects the moving object region in the 1/1 first reference image and the 1/1 second reference image by using the reduced images generated in steps S102 to S104 (step S105).

Next, the image composition section 32 performs combining processing of the 1/1 first reference image and the 1/1 second reference image by using the detection result of the moving object region detection section 31 (step S106).

In step S105, the moving object region detection processing of the moving object region detection section 31 is not particularly limited as long as the processing uses a method using a reduced image. Furthermore, in step S106, the image combining processing of the image composition section 32 is not particularly limited as long as the processing uses a method of combining two images having different imaging timings by using the detection result of the moving object region detection section 31. In the present embodiment, for example, the moving object region can be detected by a method obtained by removing processing of a reduction processing part 1650 from a moving object region detection section 202 disclosed in JP 2019-101977 A. Furthermore, images can be combined by a method similar to the processing of an image composition section 203 disclosed in JP 2019-101977 A. Hereinafter, an example of the moving object region detection processing and the image combining processing will be described.

In step S106, the moving object region detection section 31 reads the 1/1 first reference image data and the 1/1 second reference image data from the frame memory 40, and calculates a difference value between the pixel values of these images. Subsequently, the moving object region detection section 31 calculates a first moving object likelihood corresponding to the difference value. At this time, the moving object region detection section 31 calculates the first moving object likelihood for the 1/1 image by using a conversion formula in which the relationship between the difference value and the first moving object likelihood is determined in advance.

Subsequently, the moving object region detection section 31 similarly calculates the pixel value of the first reference image and the pixel value of the second reference image for the reduced images of the ¼ image, the 1/16 image, and the 1/64 image. Subsequently, the moving object region detection section 31 calculates a second moving object likelihood, a third moving object likelihood, and a fourth moving object likelihood corresponding to each of the difference values. At this time, the moving object region detection section 31 calculates each of the moving object likelihoods for each of the reduced images by using the conversion formula in which the relationship between the difference value and each of the moving object likelihoods is determined in advance.

Subsequently, the moving object region detection section 31 calculates a first edge degree corresponding to the difference value of the 1/1 image, and a second edge degree to a fourth edge degree each corresponding to the difference value of each of the reduced images. At this time, the moving object region detection section 31 calculates each of the edge degrees for each of the 1/1 image and the reduced images by using the conversion formula in which the relationship between the difference value and each of the edge degrees is determined in advance.

Subsequently, the moving object region detection section 31 determines a first composition ratio of the third moving object likelihood and the fourth moving object likelihood on the basis of the third edge degree. At this time, the moving object region detection section 31 determines the first composition ratio by using a conversion formula in which the relationship between the third edge degree and the first composition ratio is determined in advance. Subsequently, the moving object region detection section 31 generates a first combined moving object likelihood by combining the third moving object likelihood and the fourth moving object likelihood according to the first composition ratio.

Subsequently, the moving object region detection section 31 determines a second composition ratio of the second moving object likelihood and the first combined moving object likelihood by the method similar to that of the first composition ratio described above. Subsequently, by the method similar to that of the first combined moving object likelihood, the moving object region detection section 31 generates a second combined moving object likelihood by combining the second moving object likelihood and the first combined moving object likelihood according to the second composition ratio.

Subsequently, the moving object region detection section 31 determines a third composition ratio of the first moving object likelihood and the second combined moving object likelihood by the method similar to that of the first composition ratio described above. Subsequently, by the method similar to that of the first combined moving object likelihood, the moving object region detection section 31 generates a third combined moving object likelihood by combining the first moving object likelihood and the second combined moving object likelihood according to the third composition ratio. With this arrangement, the operation of step S106 ends.

Next, in step S7, the image composition section 32 calculates a fourth composition ratio corresponding to the third combined moving object likelihood. At this time, the image composition section 32 calculates a fourth composition ratio by using a conversion formula in which the relationship between the third combined moving object likelihood and the fourth composition ratio is determined in advance. Finally, the image composition section 32 combines the 1/1 first reference image and the 1/1 second reference image at the fourth composition ratio.

Hereinafter, an imaging device according to a comparative example compared with the imaging device 1 according to the first embodiment described above will be described. The imaging device according to the present comparative example is different from that of the first embodiment in a circuit configuration of a pixel.

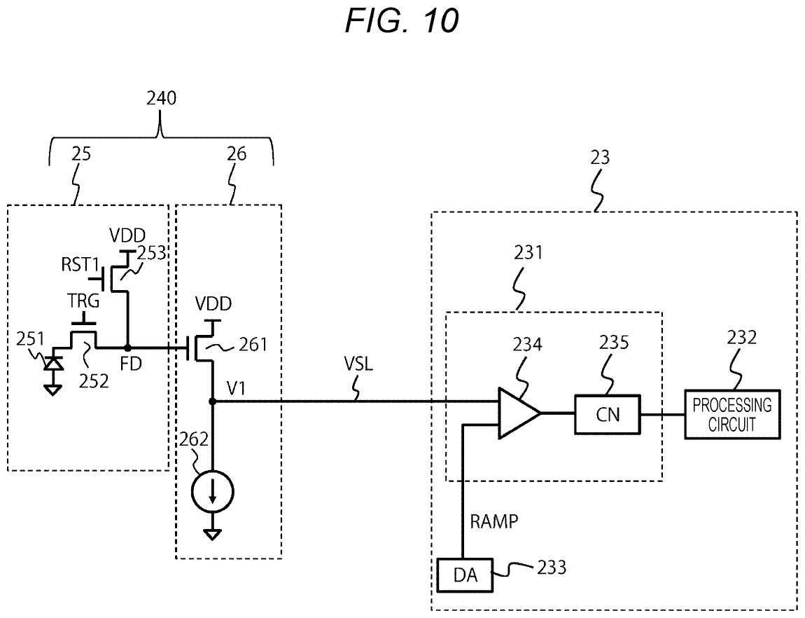

FIG. 10 is a diagram illustrating a circuit configuration of the pixel in the imaging device according to the comparative example. In FIG. 10, circuit elements similar to those of the pixel 24 according to the first embodiment described above are denoted by the similar reference signs, and redundant description will be omitted.

A pixel 240 illustrated in FIG. 10 is not provided with the signal holding circuit 27 and the second source follower circuit 28. Therefore, the sensor unit 20 of the comparative example outputs only the 1/1 image, and cannot generate a reduced image having a resolution lower than that of the 1/1 image. As a result, the logic unit 30 needs to be provided with a reduction processing section that performs processing of reducing the resolution of the 1/1 image. In this case, the area of the logic unit 30 increases. Furthermore, as the number of pieces of reduced images increases, the processing load of the reduction processing section increases.

On the other hand, according to the imaging device 1 according to the present embodiment, as described above, because the pixel 24 includes the signal holding circuit 27 and the second source follower circuit 28, not only the 1/1 image but also the reduced image can be output. Therefore, the logic unit 30 does not need to be provided with the reduction processing section described above. With this arrangement, the processing load associated with the generation of the reduced image in the logic unit 30 can be reduced. In the present embodiment, because the reference image and the reduced image can be created by adjusting the number of pieces of the selection transistors 282 provided in each of the pixels 24 in the on state, the processing load of the sensor unit 20 associated with the generation of the reduced image is substantially the same as that in the case of creating the reference image. Furthermore, because the resolution of the reduced image can be adjusted by the number of pieces of the selection transistors 282 in the on state, even if the reduced image increases, the load on the sensor unit 20 does not increase significantly.

Furthermore, in the present embodiment, because the reduction processing section is unnecessary, the area of the logic unit 30 can be reduced. Furthermore, in the sensor unit 20, because the reduced image can be generated by adjusting the driving of the selection transistors 282 as described above, the area of the sensor unit 20 does not increase. With this arrangement, the imaging device 1 can be downsized along with the reduction in the area of the logic unit 30.

Furthermore, according to the present embodiment, because the signal line VSL is commonly connected to the plurality of pixels 24 belonging to the same pixel column, the sensor unit 20 generates the reduced image by using the addition average. Furthermore, because the row selection section 22 controls the operation of the selection transistor 282 of each pixel 24 to flexibly determine the ratio of the addition average, the moving object can be detected at an optimum reduction ratio and an optimum number of times of reduction depending on the imaging target.

Moreover, in the present embodiment, it is possible to identify which of the reduced images of the reduction ratios is output from which of the pixel columns (in which order), by data embedded in the header 302 or the footer 303 of the image data 300.

### Second Embodiment

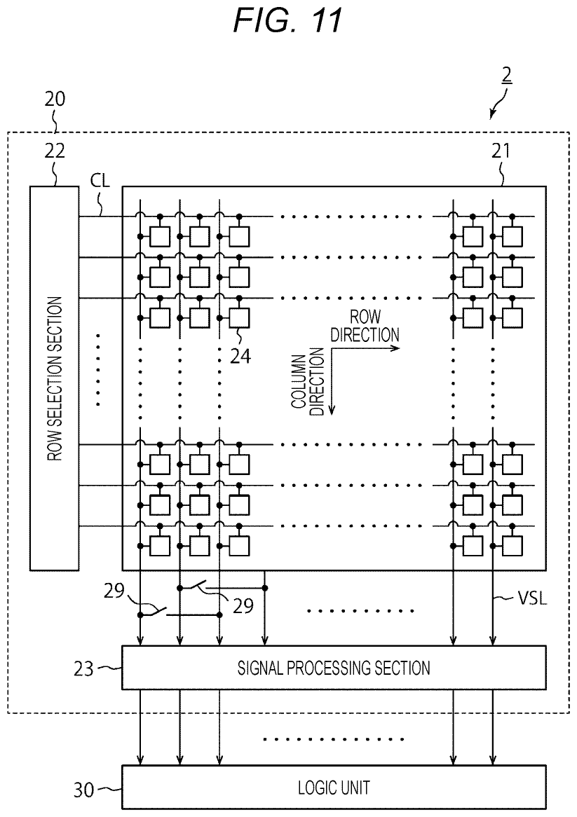

FIG. 11 is a block diagram illustrating a configuration of a sensor unit 20 of an imaging device 2 according to a second embodiment. In the present embodiment, components similar to those of the first embodiment are denoted by the same reference numerals, and are not described in detail.

The sensor unit 20 illustrated in FIG. 11 is further provided with a plurality of switch elements 29 for switching whether or not to connect signal lines VSL to each other. Each of the switch elements 29 includes, for example, an N-channel MOS transistor, and is turned on and off on the basis of a control signal input to the gate from a row selection section 22.

When the switch element 29 is turned on simultaneously with selection transistors 282 respectively connected to the two signal lines VSL connected to each other by this switch element 29, the pixel values in the pixel column direction (vertical direction) and the pixel row direction (horizontal direction) can be added. With this arrangement, the reduced image can be created. At this time, as the resolution of the reduced image decreases, the number of pieces of the switch elements 29 in the on state decreases.

Furthermore, the reduction ratio can be flexibly set by appropriately combining the combination of the switch element 29 and the on and off of the selection transistor 282.

Note that, in a pixel array section 21 according to the present embodiment, there are a first pixel column in which green pixels for receiving green light and red pixels for receiving red light are alternately aligned, and a second pixel column in which blue pixels for receiving blue light and green pixels are alternately aligned. Furthermore, the first pixel column and the second pixel column are alternately aligned in the row direction in the pixel array section 21. Therefore, the switch element 29 connects the signal lines VSL disposed apart from each other every other column in the row direction and not the signal lines VSL adjacent to each other in the row direction. However, the signal lines VSL connected to each other by the switch element 29 may be pixel columns having the same combination of received colors of pixels. Therefore, for example, in a case where the plurality of first pixel columns is aligned adjacent to each other in the row direction, the switch element 29 connects the signal lines VSL adjacent to each other.

According to the present embodiment described above, similarly to the first embodiment, because the reduced image can be generated by the sensor unit 20, the reduction processing unit becomes unnecessary in a logic unit 30. With this arrangement, the processing load of the logic unit 30 can be reduced.

Furthermore, in the present embodiment, by switching the driving of the switch element 29 for switching the connection between the signal lines VSL, the variation of the reduced image can be increased without increasing the load of the sensor unit 20.

### <Application Example to Mobile Body>

The technology according to the present disclosure (present technology) can be applied to various products. For example, the technology according to the present disclosure may be implemented in the form of a device to be mounted on a mobile body of any kind, such as an automobile, an electric vehicle, a hybrid electric vehicle, a motorcycle, a bicycle, a personal mobility, an airplane, a drone, a vessel, or a robot.

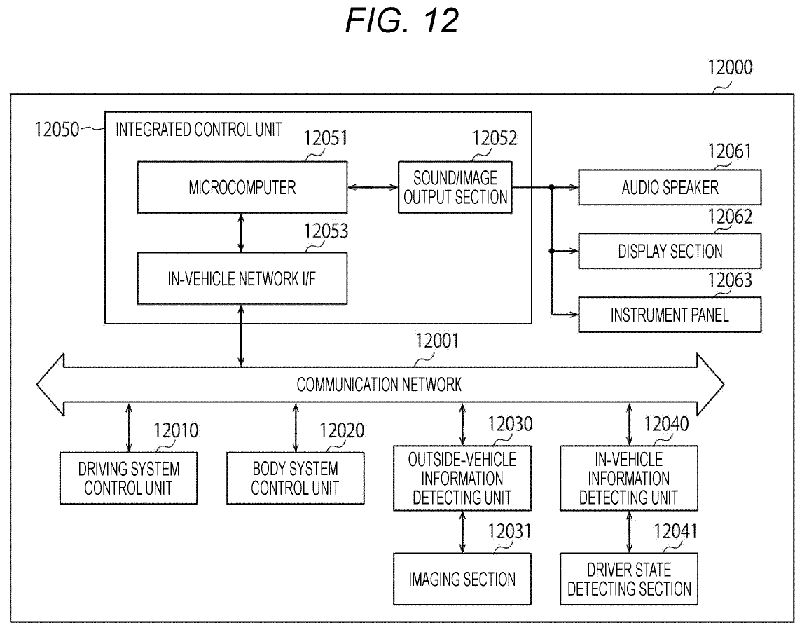

FIG. 12 is a block diagram illustrating an example of schematic configuration of a vehicle control system as an example of a mobile body control system to which the technology according to the present disclosure can be applied.

The vehicle control system 12000 includes a plurality of electronic control units connected to each other via a communication network 12001. In the example illustrated in FIG. 12, the vehicle control system 12000 includes a driving system control unit 12010, a body system control unit 12020, an outside-vehicle information detecting unit 12030, an in-vehicle information detecting unit 12040, and an integrated control unit 12050. Furthermore, as a functional configuration of the integrated control unit 12050, a microcomputer 12051, a sound/image output section 12052, and an in-vehicle network interface (I/F) 12053 are illustrated.

The driving system control unit 12010 controls the operation of devices related to the driving system of the vehicle in accordance with various kinds of programs. For example, the driving system control unit 12010 functions as a control device for a driving force generating device for generating the driving force of the vehicle such as an internal combustion engine or a driving motor, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device that can visually or auditorily notify an occupant or the outside of the vehicle of information. In the example in FIG. 12, an audio speaker 12061, a display section 12062, and an instrument panel 12063 are exemplified as the output device. The display section 12062 may include, for example, at least one of an on-board display or a head-up display.

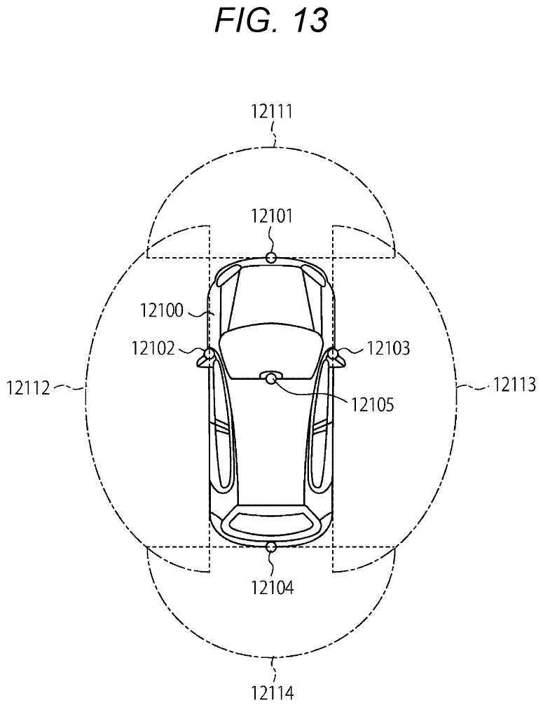

FIG. 13 is a diagram illustrating an example of the installation positions of the imaging section 12031.

In FIG. 13, imaging sections 12101, 12102, 12103, 12104, and 12105 are included as the imaging section 12031.

The imaging sections 12101, 12102, 12103, 12104, and 12105 are provided, for example, at positions such as the front nose, the side-view mirrors, the rear bumper, the back door, and an upper portion of the windshield within an interior of the vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 13 illustrates an example of imaging ranges of the imaging sections 12101 to 12104. An imaging range 12111 represents the imaging range of the imaging section 12101 provided to the front nose, imaging ranges 12112 and 12113 respectively represent the imaging ranges of the imaging sections 12102 and 12103 provided to the side-view mirrors, and an imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Moreover, the microcomputer 12051 can set a following distance to be maintained in advance in front of a preceding vehicle, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to, for example, the imaging section 12031 among the configurations described above. Specifically, the imaging device 1 and the imaging device 2 can be applied to the imaging section 12031. By applying the technology according to the present disclosure, a captured image with higher quality can be obtained, and thus, safety can be improved.

Note that the present technology can have the following configurations.

(1) An imaging device including:
a sensor unit that generates image data of a reference image obtained by imaging an imaging target region with a resolution of a maximum angle of view and image data of a reduced image obtained by imaging the imaging target region with a resolution lower than the resolution of the reference image; and
a logic unit that processes the image data, in which
the sensor unit includes:
a pixel array section including a plurality of pixels that each generates an analog pixel signal obtained by photoelectrically converting incident light from the imaging target region;
a row selection section that selects a pixel that outputs the analog pixel signal from the pixel array section according to the resolution; and
a signal processing section that generates the image data by performing digital processing on the analog pixel signal of the pixel selected by the row selection section, indicates the resolution in the image data, and outputs the image data to the logic unit.

(2) The imaging device according to (1), in which
each of the plurality of pixels includes:
a photoelectric conversion circuit having a light receiving element that photoelectrically converts the incident light;
a first source follower circuit including a first amplification transistor that amplifies an output signal of the photoelectric conversion circuit;
a signal holding circuit that holds an output signal of the first source follower circuit; and
a second source follower circuit including a second amplification transistor that amplifies a signal read from the signal holding circuit and a selection transistor that selects, on the basis of control of the row selection section, whether or not to transmit a signal amplified by the second amplification transistor to the signal processing section as the analog pixel signal.

(3) The imaging device according to (2), in which the number of selection transistors in the plurality of pixels in an on state decreases as the resolution decreases.

(4) The imaging device according to (2) or (3), in which
the plurality of pixels is aligned in a matrix in the pixel array section, and
the selection transistors each being provided in each of pixels belonging to a same pixel column in the plurality of pixels are commonly connected to one signal line.

(5) The imaging device according to (4), in which the sensor unit further includes a switch element that switches whether or not to connect the signal lines to each other on the basis of control of the row selection section.

(6) The imaging device according to (5), in which the switch element switches whether or not to connect signal lines to each other, the signal lines being connected to a pixel column having a same combination of received colors of the pixels.

(7) The imaging device according to (6), in which the switch element switches whether or not to connect signal lines to each other, the signal lines being disposed at every other position in a row direction.

(8) The imaging device according to any one of (5) to (7), in which the row selection section turns on the switch element simultaneously with the selection transistor.

(9) The imaging device according to any one of (5) to (8), in which the switch element includes an N-channel MOS transistor.

(10) The imaging device according to any one of (2) to (9), in which
the signal holding circuit includes:
a first capacitive element that holds a first signal obtained by resetting the photoelectric conversion circuit;
a first sample transistor that sets, on the basis of control of the row selection section, timing of holding the first signal in the first capacitive element;
a second capacitive element that holds a second signal generated by performing photoelectric conversion by the photoelectric conversion circuit; and
a second sample transistor that sets, on the basis of control of the row selection section, timing of holding the second signal in the second capacitive element.

(11) The imaging device according to any one of (1) to (10), in which the resolution is indicated in a header or a footer of the image data.

(12) The imaging device according to any one of (1) to (12), in which
the signal processing section includes:
an analog-to-digital (AD) converter that converts the analog pixel signal into a digital pixel signal; and
a processing circuit that generates the image data on the basis of the digital pixel signal, indicates the resolution in the image data, and outputs the image data to the logic unit.

(13) The imaging device according to any one of (1) to (12), in which
the sensor unit generates image data of two reference images having different imaging timings from each other and image data of a plurality of reduced images having different resolutions from each other, and
the logic unit includes:
a moving object region detection section that detects a moving object region in the reference image on the basis of the plurality of reduced images; and
an image composition section that combines the two reference images on the basis of a detection result of the moving object region detection section.

### REFERENCE SIGNS LIST

1, 2 Imaging device
20 Sensor unit
21 Pixel array section
22 Row selection section
23 Signal processing section
24 Pixel
25 Photoelectric conversion circuit
26 First source follower circuit
27 Signal holding circuit
28 Second source follower circuit
29 Switch element
30 Logic unit
231 AD converter
232 Processing circuit
251 Light receiving element
261 First amplification transistor
271 First capacitive element
272 Second capacitive element
273 First sample transistor
274 Second sample transistor
281 Second amplification transistor
282 Selection transistor
VSL Signal line

1. An imaging device comprising:
a sensor unit that generates image data of a reference image obtained by imaging an imaging target region with a resolution of a maximum angle of view and image data of a reduced image obtained by imaging the imaging target region with a resolution lower than the resolution of the reference image; and
a logic unit that processes the image data, wherein
the sensor unit includes:
a pixel array section including a plurality of pixels that each generates an analog pixel signal obtained by photoelectrically converting incident light from the imaging target region;
a row selection section that selects a pixel that outputs the analog pixel signal from the pixel array section according to the resolution; and
a signal processing section that generates the image data by performing digital processing on the analog pixel signal of the pixel selected by the row selection section, indicates the resolution in the image data, and outputs the image data to the logic unit.

2. The imaging device according to claim 1, wherein
each of the plurality of pixels includes:
a photoelectric conversion circuit having a light receiving element that photoelectrically converts the incident light;
a first source follower circuit including a first amplification transistor that amplifies an output signal of the photoelectric conversion circuit;
a signal holding circuit that holds an output signal of the first source follower circuit; and
a second source follower circuit including a second amplification transistor that amplifies a signal read from the signal holding circuit, and a selection transistor that selects, on a basis of control of the row selection section, whether or not to transmit a signal amplified by the second amplification transistor to the signal processing section as the analog pixel signal.

3. The imaging device according to claim 2, wherein the number of selection transistors in the plurality of pixels in an on state decreases as the resolution decreases.

4. The imaging device according to claim 2, wherein
the plurality of pixels is aligned in a matrix in the pixel array section, and
the selection transistors each being provided in each of pixels belonging to a same pixel column in the plurality of pixels are commonly connected to one signal line.

5. The imaging device according to claim 4, wherein the sensor unit further includes a switch element that switches whether or not to connect the signal lines to each other on a basis of control of the row selection section.

6. The imaging device according to claim 5, wherein the switch element switches whether or not to connect signal lines to each other, the signal lines being connected to a pixel column having a same combination of received colors of the pixels.

7. The imaging device according to claim 6, wherein the switch element switches whether or not to connect signal lines to each other, the signal lines being disposed at every other position in a row direction.

8. The imaging device according to claim 5, wherein the row selection section turns on the switch element simultaneously with the selection transistor.

9. The imaging device according to claim 5, wherein the switch element includes an N-channel metal-oxide-semiconductor (MOS) transistor.

10. The imaging device according to claim 2, wherein
the signal holding circuit includes:
a first capacitive element that holds a first signal obtained by resetting the photoelectric conversion circuit;
a first sample transistor that sets, on a basis of control of the row selection section, timing of holding the first signal in the first capacitive element;
a second capacitive element that holds a second signal generated by performing photoelectric conversion by the photoelectric conversion circuit; and
a second sample transistor that sets, on a basis of control of the row selection section, timing of holding the second signal in the second capacitive element.

11. The imaging device according to claim 1, wherein the resolution is indicated in a header or a footer of the image data.

12. The imaging device according to claim 1, wherein
the signal processing section includes:
an analog-to-digital (AD) converter that converts the analog pixel signal into a digital pixel signal; and
a processing circuit that generates the image data on a basis of the digital pixel signal, indicates the resolution in the image data, and outputs the image data to the logic unit.

13. The imaging device according to claim 1, wherein
the sensor unit generates image data of two reference images having different imaging timings from each other and image data of a plurality of reduced images having different resolutions from each other, and
the logic unit includes:
a moving object region detection section that detects a moving object region in the reference image on a basis of the plurality of reduced images; and
an image composition section that combines the two reference images on a basis of a detection result of the moving object region detection section.
